(19) United States
(12) Patent Application Publication
(10) Pub. No.: US 2007/0250308 A1
(43) Pub. Date: Oct. 25, 2007

(54) Method and device for transcoding

(75) Inventors: Jun Wei Lee, Singapore (SG); Werner Oomen, Eindhoven (NL); Fransiscus Marinus Jozephus De Bont, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/573,919

(22) PCT Filed: Aug. 8, 2005
(86) PCT No.: PCT/IB05/52629

§ 371 Date: Feb. 19, 2007

(30) Foreign Application Priority Data
Aug. 31, 2004 (EP) 04104172.4

(51) Int. Cl. G10L 19/14

(52) U.S. Cl. 704/200; 704/E19.001

(57) ABSTRACT

A method and device for transcoding a first audio or video signal represented in one compression format to a second audio or video signal represented in another compression format. The transcoding is performed by direct mapping symbols from the first signal format to symbols of the second signal format. The transcoding can be performed between different formats or between the same format but with different bitrates. Such formats may be MP3 or aac.

The present invention relates to a method and a device for transcoding an audio or video signal represented in one compression format to another audio or video signal represented in another compression format, specifically from a format to the same format with another bitrate.

Currently, there are many different kinds of audio coding formats, such as MPEG-Layer III (mp3), MPEG-AAC, WMA, etc. Also, it is often the case that (portable) audio players support a limited set of these formats. Furthermore, for each coding format, the audio material can be encoded at different bitrates, whereby usually higher bitrates corresponds to better audio quality. These factors often lead to a need to perform transcoding or conversion from format A to format B. One example is the conversion from the aac format to the mp3 format, which may be more widely supported.

It is sometimes desirable to convert from one format to the same format with a different bitrate. This usually refers to transcoding from a higher bitrate to a lower bitrate with a lower quality but smaller storage requirements. An example is the scenario where a user stores high bitrate songs on his PC, CD or DVD for high quality playback. He would like to transfer some of these songs to his hardware portable player having a different quality reproduction. These portable players are often memory-expensive, hence it is preferred to store lower bitrate items so as to accommodate more content.

The same considerations apply for video signals, which are compressed using different formats. A need may arise to convert the video signal from one format to another format or to the same format with another bitrate.

Transcoding may be performed by a concatenation of a decoder and an encoder. This is simply a straightforward decoding of format A to pcm/wav format followed by an encoding to format B or format A at a different bitrate. As another example, songs may be stored in a database server using the aac format at a high bitrate so as to preserve a high quality. Users can then download these songs, which are then, by control of the user, transcoded to a lower bitrate prior to transmission in order to enhance the download speed.

Such transcoding is described in for example

WO 00/79770, see FIG. 8 and the text at page 13. Such concatenation of a decoder and an encoder results in a process that involves a large computational complexity and leads to an increased complexity of implementation. This increased complexity would mean that the software implementation would require a larger memory footprint and a longer execution time. A hardware implementation would require a more complex design and thus take up a larger chip area and also increased power consumption. The speed of transcoding in the concatenation method is limited by the speed of the encoder and the speed of the decoder. The quality of the transcoded material can depend on the alignment of the decoder and encoder frames, which varies according to the encoder, decoder and formats used.

There are attempts to reduce the computational efforts in such transcoding. U.S. Pat. No. 5,530,750 describes a method for compressing an audio signal for recording at a magneto-optical disk. Moreover, a further compression may be obtained when transforming the already compressed audio signal from the magneto-optical medium into an IC card. Then, the signal from the magneto-optical medium is read and supplied directly, without expansion, to a buffer memory. The compressed signal is processed by an additional compressor and is then recorded on the IC card. Normally, the spectral coefficients are inversely orthogonally transformed and then orthogonally re-transformed with an increased frame length or block length. However, the frame length need not be different in all the compression modes and then no orthogonal transformation and re-transformation are needed. This patent claims priority from 1993. Since then, large achievements have been made in the art of compression, with the definition of MP3 and other formats.

Moreover, WO 01/61686 discloses a method for converting a first audio signal in a first data compression format, in which a frame includes sub-band data, to a second audio signal in a second data compression format, in which the sub-band data in the first audio signal is used directly or indirectly to construct the second audio signal without the first audio signal having to be fully decoded prior to encoding in the second data compression format.

It is recognized that a rule must be established for transcoding to a lower bitrate, otherwise it would not be known how to requantize the data, i.e. what to select for the second quantizer. In current state of the art, this rule is usually based on a psychoacoustic or bit-allocation model. In experiments and observations, without a psychoacoustic model, it has been proven that it is not possible to obtain a reasonable transcoding quality by simply arbitrarily assuming the second quantizer.

An object of the invention is to provide a method and a device for transcoding compressed audio or video signals having less complexity of implementation than a direct concatenation of a full decoder and encoder. Furthermore, the method involves high speed and high quality.

In order to fulfill said object and other objects, a method is provided for transcoding a first audio or video signal represented in one compression format to a second audio or video signal represented in another compression format, wherein the transcoding is performed by direct mapping of symbols from the first signal format to symbols of the second signal format.

In an embodiment, the mapping may be performed according to a set of rules related to quantization information. The transcoding may be performed using information in said first audio signal format as control data, said information being for example global gain, scalefactors and other bitrate information. The transcoding may be performed in the integer domain. The transcoding may take place from a first format to the same format with a different bitrate, such as a lower bitrate. The format may be MP3 audio or AAC audio.

In another embodiment, the mapping is performed by using a lookup table. The transcoding may be performed using the equation

$${S}_{q 12}^{b} = {{S}_{q 1}^{b} [ {2}^{- λ ( b )} ]}^{3 / 4}$$

$$where , \\ λ ( b ) = \frac{1}{4} {δ}_{q} - {α}_{1} {δ}_{s} ( b )$$

δ_{q}=global_gain₁₂−global_gain₁
δₛ(b)=scalefactor₁₂(b)−scalefactor₁(b)

S_{q}^{b} is the vector of quantized spectral data in scalefactor band b, and index “1” refers to the first audio signal and index “12” refers to the second audio signal. In this embodiment, the λ(b) may be restricted to a finite set of values, for example, 13 values between 0 and 3, inclusive, with 0.25 steps.

In another aspect, the invention comprises a device for performing the above-mentioned method for transcoding a first audio signal from one compression format to a second audio signal with another compression format. The device may comprise a mapping algorithm circuit for performing direct mapping of symbols from the first audio signal to symbols of the second audio signal. Moreover, the device may comprise a memory for storing transcoding values to be used for said mapping, whereby said transcoding is performed using the above-mentioned equation.

In a further aspect, the invention comprises a computer program product comprising a computer program code for carrying out the above-mentioned method steps.

Further objects, features and advantages of the invention will become apparent from the following detailed description of embodiments of the invention with reference to the appended drawings, in which:

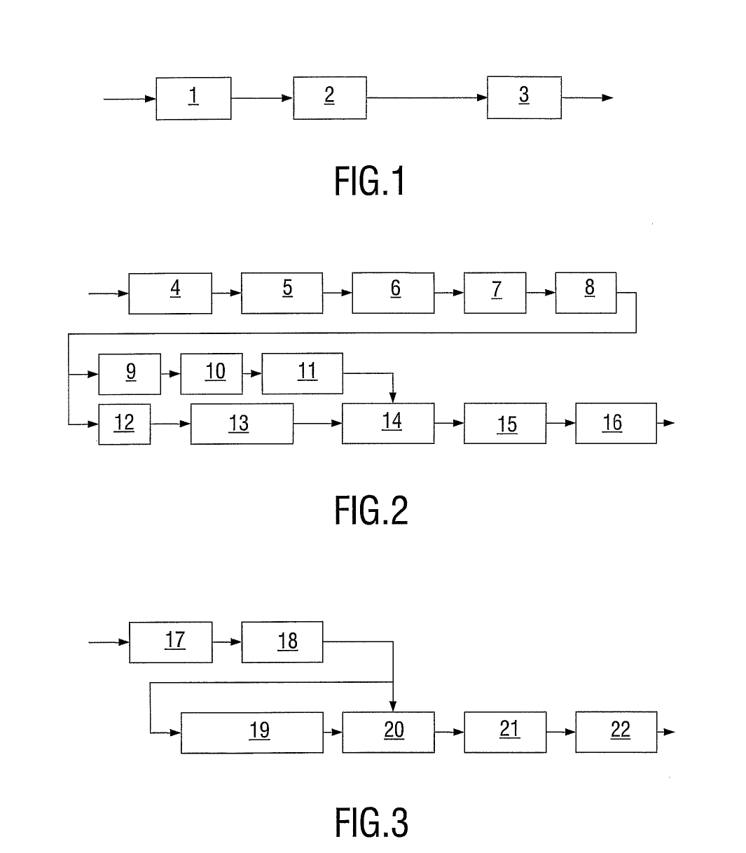

FIG. 1 is a block scheme of a prior art encoder and decoder concatenated for performing transcoding.

FIG. 2 is a block scheme disclosing a mp3 to mp3 transcoding operation.

FIG. 3 is a block scheme of a realization of a frame-aligned transcoder.

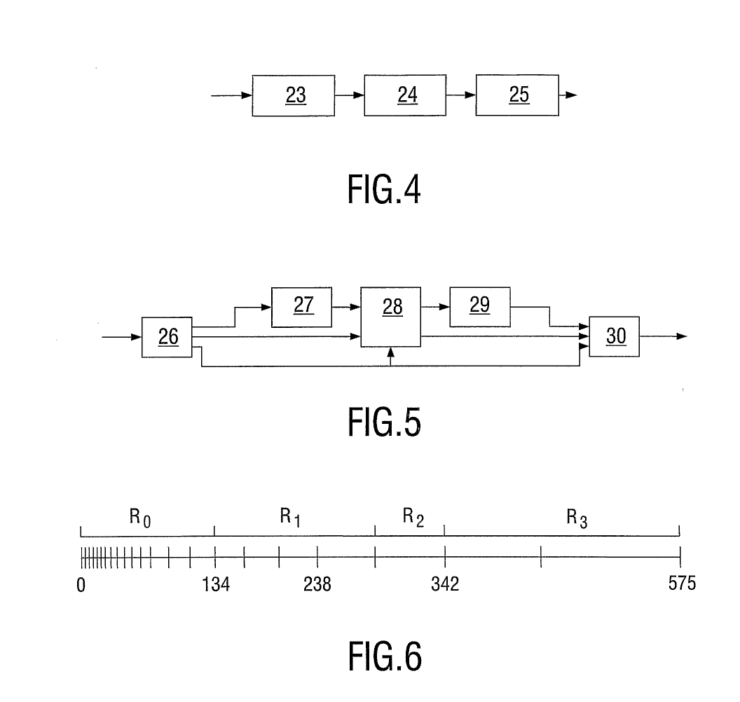

FIG. 4 is a block scheme of a bitstream transcoder according to the invention.

FIG. 5 is a block scheme of the transcoder of FIG. 4 showing a more detailed block diagram of the mapping of data from the bitstream.

FIG. 6 is a diagram in which spectral data in a granule is divided into emphasis regions.

In audio compression schemes, input pcm/wav data is usually transformed into the frequency domain and the spectral data is lossy-quantized, linear for formats like MPEG 1 Layer ½, and non-linear for formats such as mp3 and aac, according to psychoacoustic models. The quantized spectral data are then losslessly Huffman-encoded to further compress the data. Huffman coding is a compression technique that allocates fewer bits to data that occurs statistically more often and more bits to data that occurs less often.

The present invention applies a direct mapping from input symbols to output symbols. In the audio context, these symbols refer to the quantized transform coefficients. The mapping can be fixed or controlled by other information available in the bitstream.

The three transcoding issues of complexity, speed and quality are addressed in this invention. By using the direct mapping method, the implementation complexity of the transcoder is greatly decreased compared to the concatenation method, since some of the encoder and decoder operations are not required, as shown in the series of diagrams from FIG. 2 through FIG. 4.

When some kind of psychoacoustic or bit-allocation model is used, a rescaling of the coefficients is required to provide the psychoacoustic/bit-allocation measure, implying floating point operations. Furthermore, when non-linear quantization and scaling (scalefactors) are used, a 2-step requantization via integer-floating-integer transformation is assumed. The method according to the invention eliminates the use of a psychoacoustic model by defining an integer-to-integer rule set for transcoding. The exact definition rule set should differ from different audio or video material and has an impact on the transcoded quality.

Furthermore, floating-point operations can be avoided using the direct mapping method. The speed of the transcoding is also greatly improved as a result of the decreased computational operations. By using a controlled direct mapping, the audio quality of the transcoded material may be better than the frame-aligned concatenated method.

To explain in further detail, the transcoding operation using the known method of concatenating a decoder and an encoder is shown in FIG. 1. The various decoding and encoding operations for transcoding of format A to the same format A (in this case, Format A is mp3) are shown as blocks. In FIG. 1, block 1 is a “Format A Encoder” transforming the input pcm/wav signal into a signal in format A. The format A signal is decoded in block 2, “Format A Decoder” into an intermediate PCM signal. Finally, in block 3 “Format B Encoder”, the PCM signal is transformed into a Format B signal.

As can be seen, such an implementation results in many complex operations that take up CPU time and RAM space. In an optimized transcoder performing frame-aligned transcoding, it is possible to simplify the operations by removing the filter banks and/or transform operations. This is possible provided that the following conditions are met:
1) The encoder and decoder are frame aligned.
2) The filter band and/or transform operations are such that T⁻¹ T=I or very close to I, where I refers to the identity matrix and T refers to the time-to-spectral domain transform operation.
3) The psychoacoustic model is modified to operate on the spectral domain samples specific to the format being used.

A possible optimized realization of a frame-aligned transcoder is shown in FIG. 2.

According to FIG. 2, the input coded bitstream is decoded in block 4, “Huffman decoding” and re-quantized in block 5, “Requantize”. The resulting signal is anti-aliaxed in block 6, “Anti-alias operations” and transformed in block 7, “MDCT” and passed to block 8, “Filter bank”. Now the signal is in an intermediate pcm/wav-format. The signal is further input into block 9, “Filter bank” and to block 10, “MDCT”, and further to block 11, “Anti-alias operation” to influence on block 14. Moreover, the signal is input to block 12, “FFT”, and passed block 13, “Psychoacoustic model” to block 14, “Rate-distortion loop”. From there, the signal is input to block 15, “Quantizer” and exposed to encoding in block 16, “Huffman encoding”.

In FIG. 3, a method of transcoding is provided that operates directly on the bitstream and maps the input symbols to a set of output symbols. FIG. 3 illustrates a simplistic overview of the operation.

The input coded bitstream is decoded in block 17, “Huffman decoding” and transformed in block 18, “Requantize”. The intermediate signal is input to block 19, “Frequency-domain Psychoacoustic model” and further to block 20, “Rate-distortion loop”, which also receives the intermediate signal. Then, the signal is input to block 21, “Quantizer” and further to block 22, “Huffman encoding”.

As can be seen from FIG. 3, the resultant implementation is sleek, has a low computational complexity, small footprint and faster than the implementations in FIGS. 1 and 2.

Below, the transcoding of audio content from one bitstream to another bitstream of the same format is described. The method used is a direct mapping of input symbols to a set of output symbols, possibly guided by control data obtainable from within the bitstream. Such a scheme is faster and has a lower complexity when compared to the standard method of concatenating a decoder with an encoder.

FIG. 4 shows an example of an implementation of this transcoding scheme.

The input coded bitstream is input to block 23, “Huffman decoding” and further to block 24, “Mapping algorithm” and finally to block 25, “Huffman encoding”.

The format used in this example is the mp3 format. The Huffman-decoded set of input spectral data from bitstream 1 is directly mapped into a second set of spectral data, which is then Huffman-encoded into bitstream 2.

The expression “mapping” means that the spectral data is not re-transformed in any way, but simply moved to the second bitstream, according to a set of rules. One way of mapping is to multiply the spectral data with a predetermined factor as explained in more detail in the specific embodiment given below.

An embodiment of a direct mapping method will be described in detail in the following example, for the case of transcoding from the mp3 format to the mp3 format at a different bitrate.

In the mp3 format, the data in a frame is divided into 2 consecutive granules and 1 or 2 channels (coded as mono/stereo or joint-stereo). In each granule, the spectral coefficients are quantized and Huffman encoded. Let the real-valued spectral coefficients be denoted as the row vector Xᵣ. Xᵣ has a length of 576, and assumes real values from −1.0 to 1.0. The vector Xᵣ is divided into scalefactor bands, according to the MP3 format specifications, depending on the sampling frequency and window type. There are 22 scalefactor bands for long windows and 13 scalefactor bands for short windows. In this example, we focus on the case of long windows, but it can easily be extended for the case of short windows by altering the grouping of the vectors accordingly.

Let the spectral data in scalefactor band b be denoted by Xᵣ^{b}, such that Xᵣ=[Xᵣ⁰, Xᵣ¹l . . . Xᵣ²¹]. The quantization of the spectral coefficients is performed on a per-scalefactor band basis, such that:

$$\begin{matrix}Equation 1 : & \\ {X}_{r}^{b} \approx \pm {( {S}_{q}^{b} )}^{\frac{4}{3}} \cdot {2}^{global\_gain / 4} - {2}^{- α \cdot scalefactor ( b )} \cdot {2}^{ϕ} & \end{matrix}$$

where:
S_{q}^{b} is the vector of quantized spectral data in scalefactor band b, and takes on positive integer values from 0 to 8206.
α is the scalefactor multiplier and takes on 0.5 or 1 , depending on the encoder's selection.
φ consists of other constants and variables. For simplicity, let us not consider these variables for the purpose of our transcoding discussion.

The quantized vector S_{q}, essentially determines the amount of compression achieved. A coarser quantization of S_{q} leads to a higher compression ratio, but a larger amount of noise error. A coarser quantization can be achieved by increasing the global gain or decreasing the scalefactor, as observed from Equation 1.

In the case of frame-aligned transcoding, since each frame in bitstream₁ is related in time to a corresponding frame in bitstream₁₂, the transcoding can be represented as a transformation of the set of bitstream₁ parameters ψ₁ to the set of bitstream₁₂ parameters ψ₁₂, where ψ denotes the set of quantization parameters:
Ψ={S_{q}, global_gain, scalefactors, α, φ} Equation 2:

To achieve frame-aligned transcoding to a lower bitrate, the vector transformation S_{q1}→S_{q12} must be performed such that S_{q12} generally has smaller integer values than S_{q1}. In doing so, ψ₁₂ can be coded using less bits than ψ₁ and thus leading to a higher compression ratio (lower bitrate).

Below, a frame-aligned direct mapping transcoding scheme is described. Suppose that the transformation from ψ₁ to ψ₁₂ need not be driven by psychoacoustic requirements. Such a scheme may be possible if we are able to make use of the already encoded data present in the set of parameters ψ₁. For example, knowledge of the nature of the quantizer used in the encoding of bitstream, can be obtained from the quantized spectral data vector S_{q}. S_{q1} is mapped directly to S_{q12} based on a set of rules relating to the quantization information available in S_{q1}. The complexity of such an algorithm is very low as the mapping can be efficiently performed in the integer domain. Integer-to-floating point conversions, floating point-to-integer conversions, and floating point operations can be avoided. The diagram in FIG. 5 describes this scheme.

The input coded bitstream 1 is input to block 26, “Demux”, in which the signal is divided into a first signal, spectral data, which is input to block 27, “Huffman decoding”, and a second signal, “scalefactors, global gain, which is input to block 28, “Scaling and mapping” together with the decoded signal from block 27. Block 28 may comprise a lookup table in a memory, as explained below. A third signal from the demultiplexer 26 is “other bitstream data” which influences upon block 28. Block 28 emits scaled and mapped spectral data to block 29, “Huffman encoding”, for encoding before being multiplexed in block 30, “Mux” with the “other bitstream data” and “scalefactors, global gain” emitted from block 28.

Firstly, from Equation 1, we can derive the transformation ψ₁₂ =T {ψ₁} by re-scaling S_{q1} to Sᵣ₁ and then quantizing it to the integer vector S_{q12}, such that:

$$Equation 3 : \\ \begin{matrix}{( {S}_{q 12}^{b} )}^{\frac{4}{3}} \cdot {2}^{{global\_gain}_{12} / 4} \cdot {2}^{- {α}_{12} \cdot {scalefactor}_{12} ( b )} \cdot {2}^{{ϕ}_{12}} \approx {( {S}_{q 1}^{b} )}^{\frac{4}{3}} \cdot \\ {2}^{{global\_gain}_{1} / 4} \cdot {2}^{- {α}_{1} \cdot {scalefactor}_{1} ( b )} \cdot {2}^{{ϕ}_{1}}\end{matrix}$$

If we set α₁₂=α₁ and φ₁₂=φ₁, then this leads to:

Equation 4:

$$\begin{matrix}{S}_{q 12}^{b} \approx {S}_{q 1}^{b} \cdot {[ \begin{matrix}{2}^{( {global\_gain}_{1} - {global\_gain}_{12} ) / 4} \cdot \\ {2}^{- {α}_{1} ( {scalefactor}_{1} ( b ) - {scalefactor}_{12} ( b ) )}\end{matrix} ]}^{\frac{3}{4}} \\ = {S}_{g 1}^{b} \cdot {[ {2}^{- λ ( b )} ]}^{\frac{3}{4}} \\ where , \\ λ ( b ) = \frac{1}{4} {δ}_{g} - {α}_{1} {δ}_{s} ( b )\end{matrix}$$

δ_{q}=global_gain₁₂−global_gain₁ δₛ(b)=scalefactor₁₂(b)−scalefactor₁(b) Equation 5:

The quantizer relationships and variables used in the equation can be appropriately adjusted for other formats.

The standard method of first non-linearly resealing S_{q1}^{b}→Sᵣ^{b}, and then performing the non-linear quantization from Sᵣ^{b}→S_{q12}^{b}, can be computationally simplified by performing a direct re-quantization from S_{q1}^{b}→S_{q12}^{b}, using the linear relationship in Equation 4.

Furthermore, we find that since α, δ_{g} and δₛ(b) takes on a limited range of integer values, λ(b) also takes on a restricted range of values. Specifically, each increment in δ_{g} increases λ(b) by 0.25, and each increment in δₛ(b) decreases λ(b) by α, which is restricted to either 0.5 or 1.

Thus, λ(b) takes on the set of values ( . . . , −0.5, −0.25, 0, 0.25, 0.5, 0.75, . . . ). Furthermore, if we actually consider meaningful values of λ(b), this set of values is further diminished. This finite set of λ(b) values consists of only about 10 to 15 values in the neighborhood range of 0 to 3. To understand why this is so, take λ(b)<0 . This would result in S_{q12}^{b}>S_{q1}^{b}, which would (on the average) take up more bits to code. Since our objective is to reduce the transcoded bitrate, this scenario can be discarded. On the other hand, take a ‘large’ value of say λ(b)=5. Then, S_{q12}^{b}=nint(0.074 S_{q1}^{b}) and all values of the range S_{q12}^{b}≦20 leads to S_{q12}^{b}≦1. The distortion in this case is beyond our area of interest.

Having restricted the range of possibilities for the integer-to-integer translation of S_{q1}^{b}→S_{q12}^{b}, it is possible to avoid floating point arithmetic totally. One possible method is to make use of lookup tables. Suppose that λ(b) is restricted to the 13 values from 0 to 3, then the size of the lookup tables would be 98,484 elements (12 times 8207, λ(b)=0 maps the value to itself). The value of each mapping element can be stored in 2 bytes, and the total memory size required for the lookup tables would be 196,968 bytes.

The memory size required by the lookup tables can be considerably reduced in many ways. One method would be to assume that most values of S_{q1}^{b} lie within 0 and 255, which is reasonable since it is observed from most mp3 encoded material that only a very small minority of the spectral coefficient lay beyond that range. The memory size of the lookup table required in this case is 3,072 bytes. For the small minority of values exceeding 255, it is possible to perform floating-point arithmetic without incurring significant overhead.

Another alternative hardware implementation is to provide different processing paths. Instead of storing the transformation variables in memory, it is implemented as processing paths. e.g. different hardware paths for different values of lambda, instead of finding the values from memory.

A further alternative is to use equations for calculating the S_{q12}^{b} values in a rule-based mapping, e.g.

if (1<=S_{q12}^{b}<=3), S_{q12}^{b}=S_{q1}^{b}−1;

if (4<=S_{q1}^{b}<=7), S_{q12}^{b}=S_{q1}^{b}−2;

In this transcoder implementation example, the transformation ψ₁₂=T {ψ₁} is held constant for all frames. A possible definition of the mapping transformation is to fix δ_{g} and map S_{q1}^{b}→S_{q12}^{b} accordingly. This implementation however, leads to bitstream₁₂ with very audible distortion and noise. An improvement to this transformation map is proposed as follows.

The quantized spectral coefficients in each granule are first divided into a number of emphasis regions, with boundaries coinciding with scalefactor band boundaries. In the example of FIG. 6, the coefficients are divided into 4 regions, R₀, R₁, R₂, R₃, in which the spectral coefficient indexes are indicated at the horizontal axis. Each region will be transformed with a different value of λ(b). A larger value of λ(b) in a region implies a coarser re-quantization leading to increased distortion and noise, and hence a lower emphasis. A smaller value of λ(b), on the other hand, places a greater emphasis on the re-quantization of the spectral coefficients in that region so as to introduce less error. It is recalled from Equation 5 that λ(b) depends on the change in global_gain and scalefactor(b). Since global_gain affects the entire granule, the emphasis is selected by applying different values of δₛ(b) in each region.

A transformation for mp3 audio encoded at 192 kbps with reasonable robustness for a variety of audio materials can then be defined as follows:
Ψ₁₂=T{Ψ₁}, where: Equation 6:

$$T \{ . \} = \{ \begin{matrix}{δ}_{g} = 6 \\ {R}_{0} : {δ}_{s} ( b ) = 0 , {S}_{q 1}^{b} \to {S}_{q 2}^{b} , for 0 \leq b < 15 \\ {R}_{1} : {δ}_{s} ( b ) = 1 , {S}_{q 1}^{b} \to {S}_{q 2}^{b} , for 15 \leq b < 19 \\ {R}_{2} : {δ}_{s} ( b ) = 0 , {S}_{q 1}^{b} \to {S}_{q 2}^{b} , for b \geq 19 \\ {R}_{3} : {S}_{q 1}^{b} \to 0 , for spectral coefficient index > 342\end{matrix}$$

Similarly, other transformation maps may be defined. It is possible to vary the transformation map according to the input audio material, such as by using the bitrate information.

The invention can be implemented in any suitable form including hardware, software, firmware or any combination thereof. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units and processors.

Although the present invention has been described in connection with specific embodiments, it is not intended to be limited to the specific form set forth herein. In the claims, the term “comprising” does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc do not preclude a plurality. Reference signs in the claims are provided merely as a clarifying example and shall not be construed as limiting the scope of the claims in any way.

Hereinabove, the invention has been described with reference to specific embodiments. However, the invention is not limited to the various embodiments described but may be amended and combined in different manners as is apparent to a skilled person reading the present specification. The invention is only limited by the appended patent claims.

1. A method for transcoding a first audio or video signal represented in one compression format to a second audio or video signal represented in another compression format, wherein the transcoding is performed by direct mapping (24) symbols from the first signal to symbols of the second signal.

2. The method of claim 1, wherein said mapping is performed according to a set of rules, for example related to quantization information.

3. The method of claim 2, wherein said transcoding is performed using information in said first signal as control data, said information being for example global gain, scalefactors or other bitrate information.

4. The method of claim 1, wherein said transcoding is performed in the integer domain.

5. The method of claim 1, wherein said transcoding takes place from a first format to the same format with a different bitrate, such as a lower bitrate.

6. The method of claim 1, wherein the format is MP3 audio or AAC audio.

7. The method of claim 4, wherein said mapping is performed by using a lookup table or equations in a rule-based mapping.

8. The method of claim 1, wherein said transcoding is performed using the equation
$$\begin{matrix}{S}_{q 12}^{b} = {S}_{q 1}^{b} \cdot {[ {2}^{- λ ( b )} ]}^{\frac{3}{4}} \\ where \\ λ ( b ) = \frac{1}{4} {δ}_{g} - {α}_{1} {δ}_{s} ( b )\end{matrix}$$
δ_{q}=global_gain₁₂−global_gain₁
δₛ(b)=scalefactor₁₂(b)−scalefactor₁(b)
S_{q}^{b} is the vector of quantized spectral data in scalefactor band b, and index “1” refers to the first signal and index “12” refers to the second signal.

9. The method of claim 8, wherein (b) is restricted to a finite set of values, for example, restricted to 13 values between 0 and 3, inclusive, with 0.25 steps.

10. A device for performing the method of claim 1, for transcoding a first audio or video signal represented in one compression format to a second audio or video signal represented in another compression format, comprising:
a mapping algorithm circuit (24) for performing direct mapping of symbols from the first signal to symbols of the second signal.

11. The device of claim 10, further comprising a memory (28) for storing transcoding values to be used for said mapping, whereby said transcoding is performed using the equation:
$$\begin{matrix}{S}_{q 12}^{b} = {S}_{q 1}^{b} \cdot {[ {2}^{- λ ( b )} ]}^{\frac{3}{4}} \\ where \\ λ ( b ) = \frac{1}{4} {δ}_{g} - {α}_{1} {δ}_{s} ( b )\end{matrix}$$
δ_{q}=global_gain₁₂−global_gain₁
δₛ(b)=scalefactor₁₂(b)−scalefactor₁(b)
S_{q}^{b} is the vector of quantized spectral data in scalefactor band b, and
index “1” refers to the first signal and index “12” refers to the second signal.

12. A computer program product comprising computer program code for carrying out a method according to claim 1.
